(19) United States
(12) Patent Application Publication
(10) Pub. No.: US 2003/0163358 A1
(43) Pub. Date: Aug. 28, 2003

(54) Attendant management system and apparatus, mobile terminal, attendant management method, and computer-readable recording medium in which attendant management program is stored

(75) Inventor: Yasuko Omori, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/274,121

(22) Filed: Oct. 21, 2002

(30) Foreign Application Priority Data
Feb. 27, 2002 (JP) 2002-52054

(51) Int. Cl. G06F 17/60

(52) U.S. Cl. 705/8

(57) ABSTRACT

An attendant management system including an attendant-state registering section for registering states of individual attendants, a retrieving section, responsive to receipt of a retrieval request to retrieve any attendants available, for retrieving such available attendants based on the states of the individual attendants registered by said attendant-state registering section; a retrieval result displaying section for displaying the result of the retrieving; a reservation accepting section, responsive to receipt of a reservation request to reserve one of the available attendants with reference to the retrieval result, for accepting the reservation by making said attendant-state registering section register that the object attendant turns to a reserved state; and a notifying section for notifying the object attendant of the reservation. With this system, when a customer makes transactions at two or more attending areas, the customer is immediately attended to at next attending area thereby receiving improved service.

### BACKGROUND OF THE INVENTION

1. Field of the Invention

The present invention relates to an attendant management system, an attendant management apparatus, a mobile terminal, an attendant management method, and a computer-readable recording medium in which an attendant management program is stored, which preferably apply to attending to customers in a department store or the like having a number of sales areas.

2. Description of the Related Art

Generally, in a store having a plurality of sales areas (floors), such as a department store, a large furniture store or a mass appliance store, a number of sales clerks are present in each of the sales areas. A customer comes to a sales area in which the customer intends to shop and then finds an available sales clerk to whom to make an inquiry about a target commodity or to purchase the target commodity.

In such a conventional large-scale store, a customer pays for one or more purchases that have been made at each one of the plural sales areas. Therefore, when a customer intends to purchase commodities at more than one sales area in a store, the customer makes the payment for one or more purchases made at one of the sales areas and then goes to another sales area to make separate purchase and payment therein.

However, in such a conventional system described above, a customer has to find an available sales clerk at a sales area where the customer intends to continue shopping after a purchase. If sales clerks at an object sales area are not immediately available, the customer must wait until a sales clerk becomes available or finds another sales clerk available. Such waiting or searching for other available sales clerks may diminish a customer's shopping enjoyment considerably. For the store, customer dissatisfaction may lead to loss of a sales opportunity if the customer leaves the sales area to avoid having to wait or find an available sales clerk before being attended to.

When a customer purchases commodities at two or more sales areas in such a conventional system, the customer also pays for purchases at each sales area (on each floor) with cash or a credit card thereby repeating a complicated procedure. To facilitate this, the store has to install supplies for accepting payment, e.g., POS (Point Of Sales) terminals, at each sales area or on each floor, whereupon costs rise.

Generally, when accepting a payment, a conventional store issues to a customer a receipt for the transaction on which identification information (the name and/or an ID code) is printed to identify a cashier (checkout clerk) that has accepted payment from a customer.

For this reason, if a customer fails to confirm the identity of the sales clerk that has attended to the customer when making a transaction (e.g., by receiving a business card from the sales clerk), it is very difficult to identify the sales clerk after the transaction. As a result, if a customer needs to contact the sales clerk at a later date, it is difficult to make such a contact.

### SUMMARY OF THE INVENTION

With the foregoing problems in view, it is an object of the present invention to provide an attendant management system, an attendant management apparatus, a mobile terminal, an attendant management method, and a computer-readable recording medium in which an attendant management program is stored to manage a number of attendants such that, when a customer moves from one sales area to another for shopping, the customer can be attended to at different sales areas without having to wait and can make a payment for all transactions in a lump sum whereupon the service to customer is improved.

To attain the above object, as a first generic feature of the present invention, there is provided a system for managing a number of attendants, each of which attends to one or more customers at one of a plurality of attending areas, comprising: an attendant-state registering section for registering states of the individual attendants; a retrieval-request receiving section for receiving a retrieval request to retrieve any attendants available for attending to a customer at a particular one of the plural attending areas; a retrieving section, responsive to the retrieval request received by the retrieval-request receiving section, for retrieving such available attendants based on the states of the individual attendants registered by the attendant-state registering section; a retrieving result displaying section for displaying the result of the retrieving performed by the retrieving section; a reservation-request receiving section for receiving a request to reserve one of the available attendants with reference to the result of the retrieving displayed on the retrieving result displaying section; a reservation accepting section, responsive to the reservation request received by the reservation request receiving section, for accepting the reservation by making the attendant-state registering section register that the object attendant turns to a reserved state; and a notifying section for notifying the object attendant that the object attendant has been reserved by the customer.

As a preferable feature, the system may further comprise: two or more terminal units, each of which has the retrieval-request receiving section, the retrieving result displaying section, and the reservation-request receiving section; and a management unit communicably connected to each of the terminal units and having the attendant-state registering section, the retrieving section, the reservation accepting section, and the notifying section.

As another preferable feature, the terminal units may be disposed at least one at each of the two or more attending areas; each the terminal unit may include a transaction information receiving section for receiving transaction information about one or more transactions made with the customer in the attending area at which each the terminal unit is disposed; and the management unit may further includes a transaction information retaining section for retaining the transaction information received by the transaction information receiving section of each the terminal unit, and a payment accepting section for accepting a payment for the transactions made with the customer in a lump sum based on the transaction information retained by the transaction information retaining section.

As an additional preferable feature, the system may further comprise a receipt issuing section, responsive to the accepting of the payment by the payment accepting section, for issuing a receipt by printing the contents of the transactions for which the payment has been accepted based on the transaction information retained by the transaction information retaining section is printed; and a print control section for controlling the receipt issuing section such that the receipt issuing section prints identification information to identify the attendant having attended to the customer when making each of the transactions in correlation with the last-named each transaction.

As a further preferable feature, the system may further comprise a customer information receiving section for receiving customer information (a history of purchasing or the like) about the customer; and a customer information retaining section for retaining the customer information received by the customer information receiving section, each the terminal units including a customer information displaying section for displaying thereon the customer information retained in the customer information retaining section. As a still further preferable feature, each of the terminal units may be a mobile device.

As a second generic feature, there is provided an apparatus for managing a number of attendants, each of which attends to one or more customers at one of a plurality of attending areas, comprising: an attendant-state registering section for registering states of the individual attendants; a retrieving section, responsive to receipt of a retrieval request to retrieve any attendants available for attending to a customer at a particular one of the plural attending area, for retrieving such available attendants based on the states of the individual attendants registered by the attendant-state registering section; a reservation accepting section, responsive to receipt of a reservation request to reserve one of the available attendants with reference to the result of the retrieving, for accepting the reservation by making the attendant-state registering section register that the object attendant turns to a reserved state; and a notifying section for notifying the object attendant that the object attendant has been reserved by the customer.

As a preferable feature, the apparatus may further comprise: a transaction information retaining section for retaining transaction information about one or more transactions made with the customer; and a payment accepting section for accepting a payment for the transactions made with the customer in a lump sum based on the transaction information retained by the transaction information retaining section.

As another preferable feature, the apparatus may be further comprise a print control section for controlling, when the payment accepting section accepts the payment, printing identification information to identify the attendant having attended the customer when making each of the transactions in correlation with the last-named each transaction.

As a third preferable feature, there is provided a mobile terminal operable by an attendant that attends to one or more customer at one of a plurality of attending areas, comprising a retrieval-request receiving section for receiving a retrieval request to retrieve any attendants available for attending to a customer at a particular one of the plural attending areas; a retrieving result displaying section for displaying a result of retrieving performed in response to the retrieval request received by the retrieval-request receiving section; and a reservation-request receiving section for receiving a request to reserve one of the available attendants with reference to the result of the retrieving displayed on the retrieving result displaying section. As a still further preferable feature, the apparatus may further comprise a customer information retaining section for retaining the customer information about the customer.

As a fourth generic feature, there is provided a method for managing a number of attendants, each of which attends to one or more customers at one of a plurality of attending areas, comprising the steps of: (a) registering states of the individual attendants; (b) receiving a retrieve request to retrieve any attendants available for attending to a customer at a particular one of the plural attending areas; (c) retrieving, responsive to the retrieval request received in the retrieval-request receiving step (b) such available attendants based on the states of the individual attendants registered in the attendant-state registering step (a); (d) displaying the result of the retrieving in the retrieving step (c); (e) receiving a request to reserve one of the available attendants with reference to the result of the retrieving displayed in the retrieving result displaying step (d); (f) accepting, responsive to the reservation request received in the reservation request receiving step (e), the reservation by registering that the object attendant turns to a reserved state; and (g) notifying the object attendant that the object attendant has been reserved by the customer. As a still further preferable feature, the apparatus may further comprise a customer displaying section for displaying thereon the customer information about the customer.

As a fifth generic feature, there is provided a computer-readable recording medium in which a customer attending management program for managing a number of attendants, each for attending to one or more customers at one of a plurality of attending areas, is stored, the program instructing a computer to function as: an attendant-state registering section for registering states of the individual attendants; a retrieving section, responsive to receipt of a retrieval request to retrieve any attendants available for attending to a customer at a particular one of the plural attending area, for retrieving such available attendants based on the states of the individual attendants registered by the attendant-state registering section; a reservation accepting section, responsive to receipt of a reservation request to reserve one of the available attendants with reference to the result of the retrieving, for accepting the reservation by making the attendant-state registering section register that the object attendant turns to a reserved state; and a notifying section for notifying the object attendant that the object attendant has been reserved by the customer.

As a preferable feature, the program may further instruct a computer to function as: a transaction information retaining section for retaining transaction information about one or more transactions made with the customer; and a payment accepting section for accepting a payment for the transactions made with the customer in a lump sum based on the transaction information retained by the transaction information retaining section.

As another preferable feature, the program may further instruct a computer to function as a print control section for controlling, when the payment accepting section accepts the payment, printing identification information to identify the attendant having attended to the customer when making each of the transactions in correlation with the last-named each transaction. As a still further preferable feature, the program may instruct a computer to function as a customer information retaining section for retaining the customer information about the customer It is possible to guarantee the following advantages in terms of an attendant management system, an attendant management apparatus, a mobile terminal, an attendant management method, and a computer-readable recording medium in which an attendant management program is stored, of the present invention:

(1) Any attendants available for attending to a customer to reserve one for the customer are retrieved based on states of the individual attendants registered. As a result, since a customer does not have to find an available attendant at an attending area or to wait to be attended to until a sales clerk becomes available, it is possible to enhance service to customers. The advantage is also of benefit to the store in terms of avoiding loss of sales opportunity.

(2) A notification to an object attendant that the object attendant has been reserved by a customer allows the object sales attendant to surely recognize the reservation without time delay.

(3) Since, when transactions are made with a customer at two or more of the attending areas, transactions information about the transactions is input and the payments for the transactions are accepted in a lump sum, it is possible to improve the service to a customer, reducing the labor and time for the individual payments. As an advantage for a store, since each attending area does not have to have equipment installed for accepting payment, it is possible to reduce the costs for facilities and the amount of small change that is needed.

(4) In addition to the contents of the transactions, identification information to identify the attendant having attended to the customer when making each of the transactions is printed on a receipt issued in correlation with each transaction. As a result, it is possible for a customer to specify the attendant that attended to that customer when making a particular transaction with reference to the receipt thereby improving the service to the customer.

(5) Customer information (a history of purchasing or the like) about each customer is received and retained so that attendants or the like confirm the customer information where upon it is possible to provide customers with further improved service.

(6) Since inputs of a retrieval request and a reservation request and a display of a retrieval result are performed on mobile terminals carried by the attendants, it is possible to deal with such inputs and the display with ease.

(7) A receipt issued has two regions: a transaction information printing region including at least the contents of the transactions; and a sales clerk information printing region including the attendant that attended to the customer when making each of the transactions. It is possible to easily specify the attendant that attended to the customer when making each transaction with reference to the issued receipt thereby enhancing service to the customer.

Other objects and further features of the present invention will be apparent from the following detailed description when read in conjunction with the accompanying drawings.

### BRIEF DESCRIPTION OF THE DRAWINGS

FIG. 1 is a block diagram schematically showing an attendant management system according to a first embodiment of the present invention;

FIG. 2 is a schematic diagram showing a mobile terminal used in the attendant management system of FIG. 1;

FIG. 3 is a diagram showing an example of data structure retained in a customer DB of the attendant management system of FIG. 1;

FIG. 4 is a diagram showing an example of data structure retained in a sales clerk DB of the attendant management system of FIG. 1;

FIGS. 5 and 6 are diagrams respectively showing examples of data structure retained in a transaction DB of the attendant management system of FIG. 1;

FIGS. 7 through 13 are diagrams respectively showing examples of attendant management WEB pages used in the attendant management system of FIG. 1;

FIG. 14 is a diagram showing an example of a payment screen displayed on a monitor of a payment terminal of the attendant management system of FIG. 1;

FIG. 15 is a diagram showing an example of a receipt printed by the payment terminal of the attendant management system of FIG. 1;

FIG. 16 is a flow diagram illustrating a succession of procedural steps of a reception performed by a reception terminal of the attendant management system of FIG. 1;

FIG. 17 is a flow diagram illustrating a succession of procedural steps of attending to a customer at an individual sales area by an attendant using a mobile terminal of FIG. 2;

FIG. 18 is a flow diagram illustrating a succession of procedural steps for accepting a payment performed on the payment terminal of the attendant management system of FIG. 1;

FIG. 19 is a diagram showing a modification of a sales clerk retrieving screen of the attendant management system of FIG. 1; and

FIG. 20 is a diagram showing a modification of retrieving result displaying screen of the attendant management system of FIG. 1.

### DESCRIPTION OF THE PREFERRED EMBODIMENTS

A preferred embodiment of the present invention will now be described with reference to the accompanying drawings.

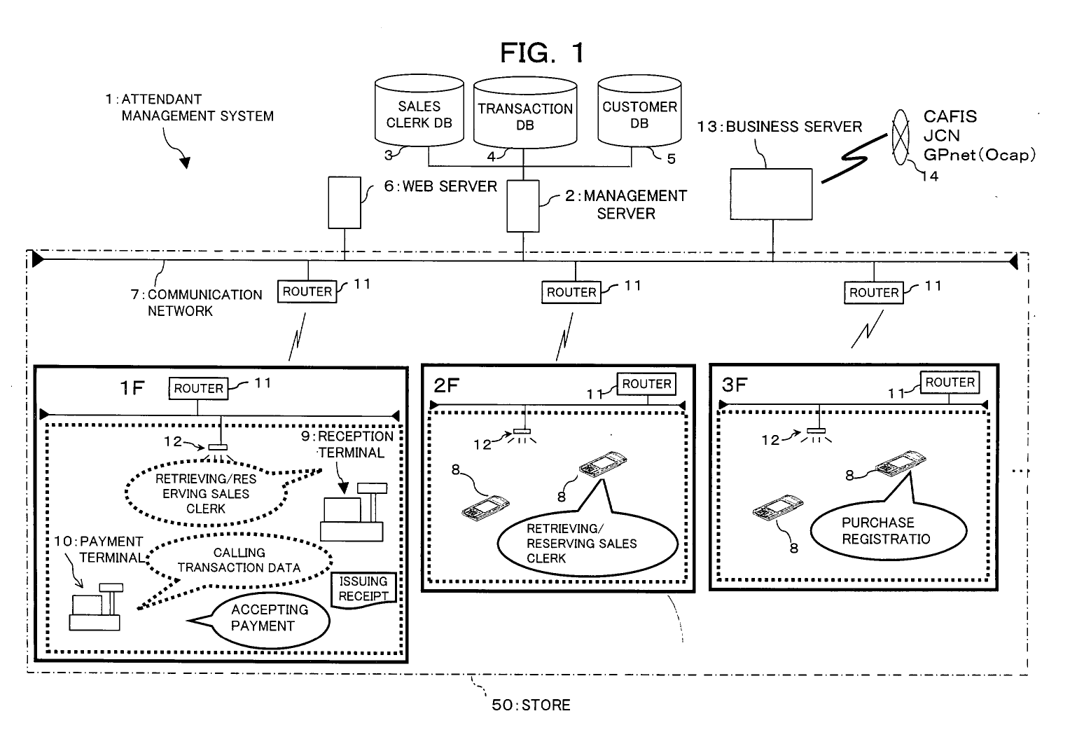

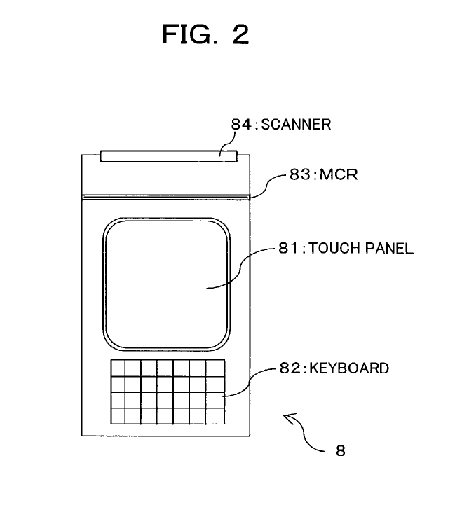

FIG. 1 shows an attendant management system according to a first embodiment of the present invention; and FIG. 2 shows a mobile terminal (a terminal unit) used in the attendant management system of FIG. 1.

Attendant management system 1 manages a number of sales clerks (attendants), each of which attends to customers at one of a plurality of sales areas (floors or sales departments) in store 50. As shown in FIG. 1, attendant management system 1 comprises management server (management unit) 2 (serving to function as a sales-clerk-state registering section, a retrieving section, a reservation accepting section, and a notifying section, which are described later), sales clerk DB 3, transaction DB (transaction information retaining section) 4, customer DB (customer information retaining section) 5, WEB server 6, communication network 7, one or more mobile terminals 8 (serving to function as a sales clerk information receiving section, a retrieval-request receiving section, a retrieving result displaying section, a reservation-request receiving section, a transaction information receiving section, a customer information receiving section, a customer information displaying section, which are described later), reception terminal (a reservation-request receiving section) 9, payment terminal (serving to function as a payment accepting section, a receipt issuing section, a receipt issuing apparatus, a print control section, a transaction contents printing section, an attendant information printing section) 10, and business server 13.

In the illustrated example, attendant management system 1 applies to store 50 that sells, for example, electric appliances and their attribute commodities. Store 50 has a several floors, each divided into a plurality of seals areas (e.g., a PC selling area and a vacuum cleaner selling area). At least a reception counter and a payment accepting counter are installed on the first floor (1F). FIG. 1 illustrates three floors of the first through the third floors, which are a part of the several floors of store 50, for convenience. Throughout this embodiment, DB stands for a database.

Individual mobile terminal 8 serves as an information processor carried by an individual sales clerk (attendant) disposed in one of the selling areas, and includes an unillustrated wireless LAN interface thereby facilitating wireless communication with WEB server 6 and management server 2 via communication network 7 having routers 11 and access points 12. The individual sales clerk operates mobile terminal 8 to retrieve and reserve a sales clerk, and to look through a purchasing history of a customer and a notification that the individual sales clerk has been reserved by a customer.

Individual mobile terminal 8 comprises touch panel 81, keyboard 82, MCR 83, and scanner 84, as shown in FIG. 2. MCR (Magnetic Character Reader) 83 reads data magnetically-stored on a card (a member card, or an ID card for each sales clerk; hereinafter also simply called a magnetic card). In the illustrated embodiment, when MCR 83 reads data magnetically recorded on a customer's member card or a sales clerk's IC card, mobile terminal 8 inputs information about a customer or a sales clerk without inputting the information through keyboard 82.

MCR 83 also reads information magnetically stored on a credit card, a cash card, and a magnetic card on which electronic money is stored. Attendant management system 1 accepts a payment for one or more transactions made with a customer (purchasing a commodity by the customer or the like) using the cards for payment based on the information obtained through MCR 83.

Mobile terminal 8 completes accepting a payment in attendant management system 1. Alternatively, mobile terminal 8 registers a transaction of purchasing a commodity of a customer, and then later-described payment terminal 10 accepts the payment for the registered transaction.

Scanner 84 has an unillustrated laser irradiating section and laser receiving section, and serves to function as a barcode reader to read a barcode on a commodity, a customer's member card or the like. A sales clerk scans information of a barcode attached to a commodity with a scanner 84 whereupon information about the transaction (e.g., the number or the price of the commodity; transaction information) is input into mobile terminal 8. Namely, also scanner 84 serves to function as a transaction information receiving section to receive information about a transaction made with a customer.

Keyboard 82 is in the form of a numeric keypad for example with which a sales clerk performs various inputs and selections. Touch panel 81 displays thereon a screen to register a commodity purchased by a customer, a later-described WEB page provided by WEB server 6, or other information. Further, a sales clerk touches touch panel 81 to input or select information that is to be received by mobile terminal 8.

In the illustrated embodiment, a sales clerk makes input (or selection) via either touch panel 81 or keyboard 82. As a result, a sales clerk inputs information on an attendant management WEB page through touch panel 81 and keyboard 82.

Mobile terminal 8 comprises an unillustrated CPU (Central Processing Unit) or memory thereby executing OS (Operating System) and applications activated on the OS.

For example, an application to input and register (hereinafter also called a purchase registration) information about a transaction made with a customer (i.e., information about a commodity that is to be purchased by the customer) is installed in mobile terminal 8. The application receives input transaction information (hereinafter also called purchase information) about a transaction (of purchasing a commodity) to send the transaction information to management server 2. Purchase information about a transaction made with a customer is therefore input to management server 2. Purchase information includes information (e.g., a commodity code) to identify a commodity purchased by a customer; the name and the price of the commodity, and quantity of the purchased commodities or the like.

As a result, the application makes mobile terminal 8 function as a POS (Point Of Sales) terminal.

Mobile terminal 8 reads a barcode attached to a commodity with scanner 84 or receives information of a barcode input via touch panel 81 or keyboard 82 in order to obtain the commodity code or other information whereupon the commodity code or other information obtained is sent to management server 2 for a purchase registration.

In the illustrated example, an individual sales clerk in one of the plural sales departments (sales areas) carries mobile terminal 8 to input transaction information. When a customer makes transactions at two or more of the plural sales department, transaction information of each of the transactions is input through mobile terminal 8 (touch panel 81, keyboard 82, and scanner 84), disposed at the corresponding sales department where the transactions are made.

Management server 2 stores transaction information input from individual mobile terminals 8 in later-described transaction DB 4 and customer DB 5. There by touch panel 81, keyboard 82, and scanner 84 serve to function as a transaction information receiving section to receive transaction information about a transaction made with a customer respectively or in combination, and further to function as a customer information receiving section to receive customer information (a purchase history or the like) about a customer.

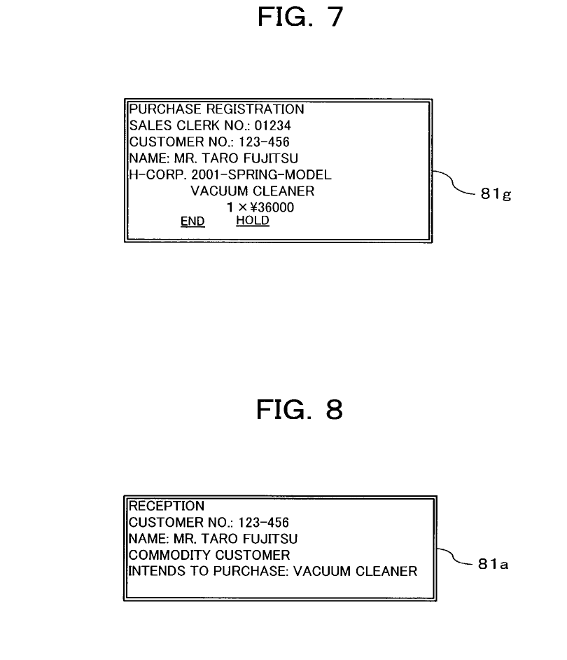

In the illustrated embodiment, browser software is installed in each mobile terminal 8 so that a sales clerk can look through attendant management WEB pages (see FIGS. 7 through 14) provided by later-described WEB server 6. The browser software displays such attendant management WEB pages provided by WEB server 6 on touch panel 81. A sales clerk carrying mobile terminal 8 looks at such attendant management WEB pages through touch panel 81 of mobile terminal 8. Attendant management WEB pages will be described in detail later.

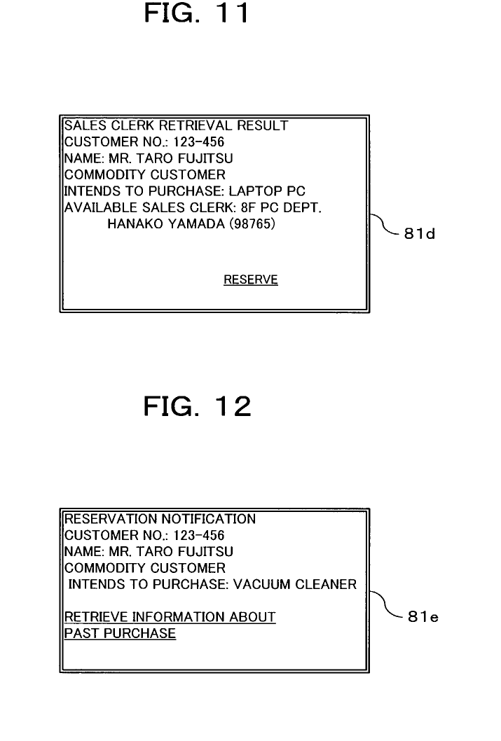

The browser software displays a retrieval result screen 81d (see FIG. 11, described in detail later) on touch panel 81, which serves therefore to function as a retrieving result displaying section to display thereon a result of retrieving any sales clerk available to attending to a customer. The browser software displays a history of purchasing of a customer (customer information) or other information obtained from customer DB 5 on touch panel 81 whereupon touch panel 81 serves to function as a customer information displaying section to display thereon customer information about a customer so that a sales clerk looks through the customer information on touch panel 81.

Each sales clerk inputs their current state (standing-by, attending to a customer, or taking a rest) through touch panel 81 or keyboard 82 of mobile terminal 8 that the clerk is carrying every time the state of the sales clerk changes. Namely, when a sales clerk changes to a state of standing-by to attend to a customer (i.e., after a rest, or completion of attending to a customer), the sales clerk inputs the state of “standing-by” from mobile terminal 8; when the sales clerk starts taking a rest, the state is changed to “taking a rest” via mobile terminal 8; and when the sales clerk starts attending to a customer, the sales clerk changes the state to “attending to a customer” using mobile terminal 8. In the illustrated embodiment, since all of the sales clerks carry individual mobile terminals 8, it is possible to input the state of an individual customer with ease. The states of the sales clerks input are sent to management server 2 via communication network 7 to be stored in sales clerk DB 3 (to be described later).

Further, a sales clerk inputs information (a name and a member number) to identify each customer with touch panel 81 and keyboard 82, or reads information (to identify each customer) previously recorded on a member card of the customer with MCR 83 or scanner 84 when inputting purchase information (performing a purchase registration).

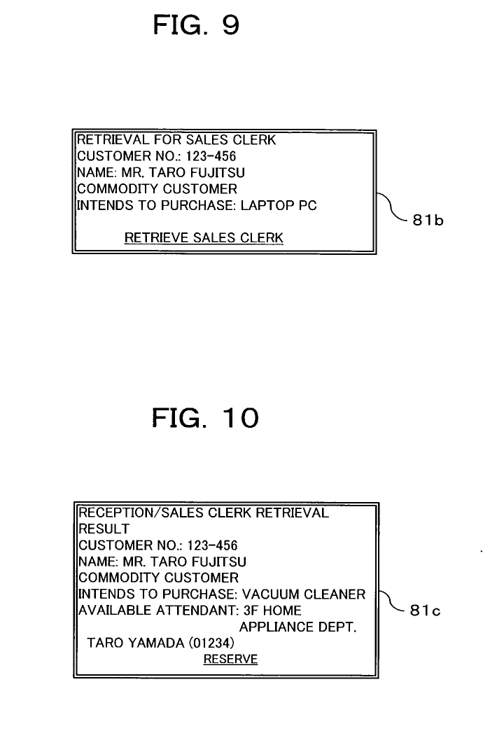

A sales clerk inputs a retrieval request to retrieve states of any other sales clerks from touch panel 81 or keyboard 82. In detail, a sales clerk inputs a retrieval request for any available sales clerk into sales clerk retrieval screen 81b (see FIG. 9; to be described later) displayed on touch panel 81 in this embodiment. For example, a sales clerk asks a customer that the sales clerk has just attended to which department the customer intends to visit next or what the customer intends to purchase next, and then inputs a retrieval request via mobile terminal 8 in order to retrieve the states of sales clerks disposed at a department which the customer intends to visit.

After such a retrieval, the sales clerk inputs a reservation request to reserve one of retrieved sales clerks available for the customer using keyboard 82 or touch panel 81 on a sales clerk reservation screen 81d (see FIG. 11; to be described later) displayed on touch panel 81 in the present invention.

Namely, mobile terminal 8 (keyboard 82 and touch panel 81) serves to function as a retrieval-request receiving section to receive a retrieval request to retrieve any sales clerk available to attend to a customer, and also as a reservation-request receiving section to receive a request to reserve one of the sales clerks available to attend to customers.

Each information processor (mobile terminal 8) functions as the sales clerk information receiving section, the retrieval-request receiving section, the retrieving result displaying section, the reservation-request receiving section, the transaction information receiving section, the customer information receiving section, the customer information displaying section by CPU (Central Processing Unit; not shown) executing one or more programs stored in a computer-readable recording medium (e.g., a memory, a magnetic recording medium, a flexible disc, a memory card, a magneto-optic recording medium, a CD-ROM, a CD-R, a CD-RW, a DVD, a DVD-R, and a DVD-RW).

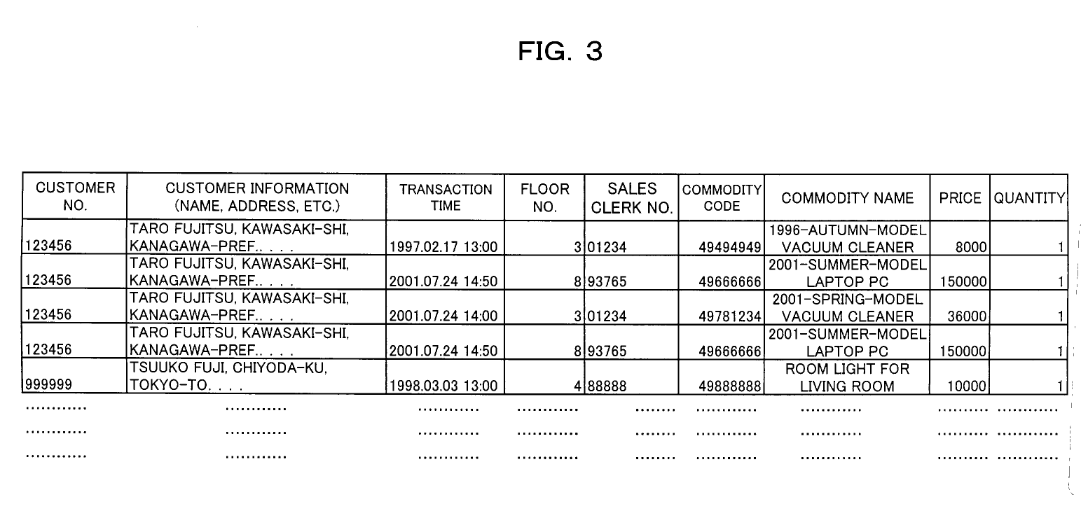

Customer DB 5 retains a purchase history of a customer (customer information about a customer). FIG. 3 shows an example of data structure retained in customer DB 5 of attendant management system 1. Customer DB 5 retains a purchase history of a customer in correlation with customer information about the customer. More particularly customer DB 5 has, as shown in FIG. 3, indexes of a customer number, customer information, a transaction date, a floor number, a sales clerk number, a commodity code, a commodity name, a commodity price, and a quantity, which indexes are associated with each other. Upon completion of the payment for each purchase of a commodity, the information about the transaction of the purchase is added into customer DB 5 as a purchase history.

A customer number is assigned to an individual customer for identification; customer information is an address and/or a telephone number of an individual customer; a transaction date is a date on which a customer has purchased a commodity; a floor number represents a floor of store 50 on which a customer has purchased a commodity; a sales clerk number is previously assigned to an individual sales clerk that attended to the customer for identification; a commodity name is that of the commodity that the customer has purchased; a commodity code is allocated to an individual commodity in order to identify the commodity that has been purchased by the customer; a price represents the unit price for the commodity purchased; and a quantity represents the number of identical commodities purchased by the customer at that time.

Sales clerk DB 3 retains sales clerk information (state of each sales clerk) and additionally retains department information of which each sales clerk is in charge.

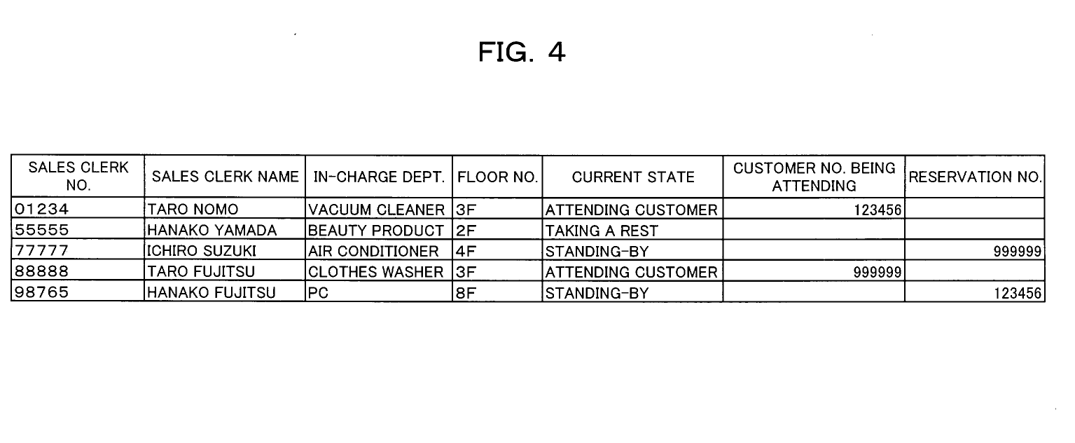

FIG. 4 shows an example of data structure retained in sales clerk DB 3 of attendant management system 1. As shown in FIG. 4, sales clerk DB 3 retains a sales clerk number, a sales clerk name, an in-charge department, a floor number, a current state, a customer number being attended to, and a reservation number in correlation with each other.

A sales clerk number is assigned to each sales clerk in advance for identification; a sales clerk name is the name of the sales clerk; an in-charge department represents a department (a sales area or commodities that are sold) at which the sales clerk is in charge of attending to a customer; a floor number represents a floor on which the sales clerk is in charge of attending to a customer; a state indicates the state of the sales clerk, which state is one of “attending to a customer”, “standing-by” and “taking a rest”; a customer number being attending to represents a customer that a sales clerk is attending to and is therefore filled only while the sales clerk is attending to a customer; and a reservation number represents a customer number of an ensuing customer that is to be attended by the sales clerk and is therefore filled only while the sales clerk is reserved by an ensuing customer.

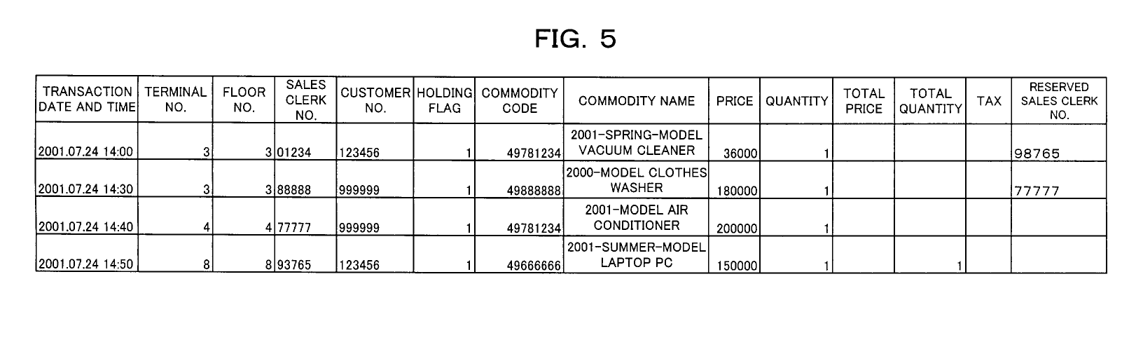

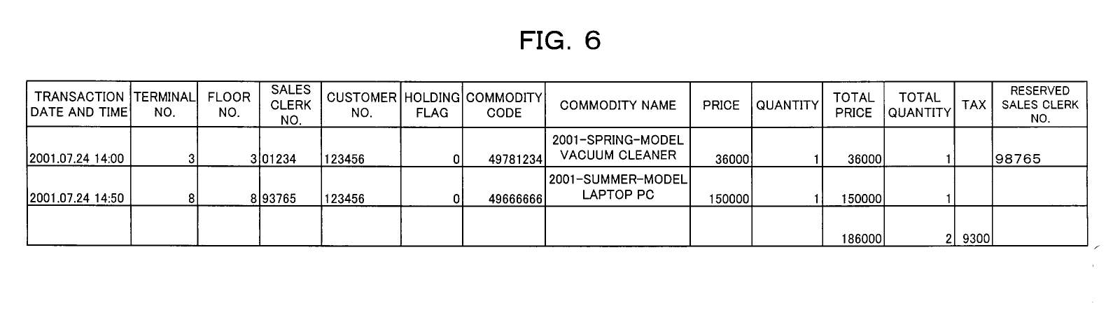

Transaction DB 4 retains transaction (purchase) information about a transaction made with a customer (a purchase history of a customer). Such transaction information includes a transaction whose purchase registration has been performed and/or a transaction whose payment has been made. FIGS. 5 and 6 respectively show examples of data structure retained in transaction DB 4 of attendant management system 1. FIG. 5 illustrates an extract from transactions for which payment has not yet been made (hereinafter the state is also called “holding state”). Conversely, FIG. 6 illustrates transactions identical to those in FIG. 5, for which the payment has been made in relation to a particular customer having customer number 123456.

Each transaction in FIG. 5, which has not yet been settled (being in a holding state), is made with either one of two customers whose customer numbers are 123456 and 999999.

As shown in FIGS. 5 and 6, transaction DB 4 retains a transaction time, a terminal number, a floor number, a sales clerk number, a customer number, a holding flag, a commodity code, a commodity name, a price, a quantity, a total price, a total quantity, a tax, and a reserved sales clerk number in correlation with each other. The indexes used in transaction DB 4 whose names are identical to those of sales clerk DB 3 and/or customer DB 5 refer to indexes identical or substantially identical to those used in indexes of sales clerk DB 3 and/or customer DB 5, so any repetitious description is omitted here.

A transaction time represents a time and date when a transaction is made with a customer; a terminal number is information to identify mobile terminal 8 that has received information about the transaction, and a peculiar terminal number is allocated to each mobile terminal 8 beforehand; and a holding flag indicates whether or not the transaction is in a holding state. In the illustrated embodiment, when a transaction has been made, a holding flag is set to “0”. Conversely, a transaction in a holding state, that is a transaction for which a purchase registration has been performed but for which payment has not been made yet, sets a holding flag of “1”.

When a holding flag for a transaction is set to “1”, the customer is still shopping in store 50 and has not made the payment for the transaction yet. Since FIG. 5 shows an example of transactions in a holding state, holding flags for all transactions are set to In FIGS. 5 and 6, a total price and a total quantity represent the total sum of the price and of the quantity of the transaction; a tax represents tax (e.g., a consumption tax) put on the transaction. Only when the payment for a transaction has been made, corresponding information is input into the indexes of a total price, a total quantity, and a tax for the transaction, as shown in FIG. 6. These indexes for a transaction in a holding state are filled with no information.

WEB server 6 is communicably connected to at least management server 2, reception terminal 9, and each Mobile terminal 8 via communication network 7. WEB server 6 provides WEB pages (attendant management WEB pages; see FIGS. 7 through 13) so that sales clerks can browse the WEB pages on mobile terminals 8 and reception terminal 9. WEB server 6 includes a CGI (Common Gateway Interface) and a back-end program (a gateway), which do not appear in the accompanying drawings, in order to send and receive various data (instructions) between management server 2.

FIGS. 7 through 13 respectively show examples of attendant management WEB pages used in attendant management system 1. FIG. 7 shows an example of a screen (purchase registration screen 81g) for receiving transaction information, which screen is displayed on touch panel 81 of mobile terminal 8; FIG. 8, an example of customer information; FIG. 9, an example of a sales clerk retrieval screen; FIGS. 10 and 11, respectively examples of a sales clerk retrieval result screen; FIG. 12, an example of a reservation notification screen; and FIG. 13, an example of displaying a purchase history of a customer.

The example of purchase registration screen 81g in FIG. 7 illustrates a case that a customer (whose name is Taro Fujistu) purchases a vacuum cleaner manufactured by H Corporation.

Purchase registration screen 81g of FIG. 7 includes “hold” and “end” buttons, which are selectively pressed. When a customer intends to purchase another commodity in addition to the commodity displayed on purchase registration screen 81g, a sales clerk selects the “hold” button. On the other hand, when a customer does not intend to continue shopping, the “end” button is selected.

If a sales clerk selects the “end” button, transaction information displayed on purchase registration screen 81g is sent to management server 2 through communication network 7 to be stored in transaction DB 4 as described later and then the operation performed by the sales clerk for the customer is completed. Conversely, if a sales clerk selects the “hold” button, transaction information displayed on purchase registration screen 81g is sent to management server 2 through communication network 7 to be stored in transaction DB 4 and at the same time a screen (not shown) to receive information about an ensuing commodity that a customer intends to purchase is displayed on touch panel 81 so that the sales clerk can retrieve any sales clerks available for attending to the customer when purchasing the target commodity.

Customer information screen 81a of FIG. 8 provides customer information or the like, and is displayed on touch panel 81 of mobile terminal 8 or a monitor of reception terminal 9. Customer information to be displayed on customer information screen 81a is obtained by scanner 84 of mobile terminal 8 or an unillustrated scanner of reception terminal 9 scanning a member card possessed by a customer.

Sales clerk retrieval screen 81b is used to input a retrieval request to retrieve any sales clerks available for attending to a customer, and is displayed on touch panel 81 of mobile terminal 8 or a monitor of reception terminal 9. A sales clerk or an operator of reception terminal 9 selects “retrieve sales clerk” on sales clerk retrieval screen 81b whereupon any sales clerks available to attend to the customer are retrieved. The example of FIG. 8 is the case that a customer (named Fujitsu Taro) wishes to purchase a laptop PC.

WEB server 6 sends a retrieval request, which has been received on sales clerk retrieval screen 81b, to management server 2 via the CGI and the back-end program. Responsive to the retrieval request, management server 2 retrieves any sales clerks available to attend to a customer.

FIGS. 10 and 11 respectively show examples of retrieval result screens in response to the retrieval request input on sales clerk retrieval screen 81b (FIG. 9). Retrieval result screen 81c of FIG. 10 is displayed on the monitor of reception terminal 9. In FIG. 10, a customer (Taro Fujitsu) wishes to purchase a vacuum cleaner.

Retrieval result screen 81d of FIG. 11 is displayed on touch panel 81 of mobile terminal 8, and shows that customer (Taro Fujitsu) wishes to purchase a laptop PC.

WEB server 6 obtains the retrieval result for any available sales clerks, which retrieval has been performed by management server 2 in response to the retrieval request, through the CGI and the back-end program to display the retrieval result on retrieval result screen 81c or 81d.

A sales clerk selects a “reserve” button on retrieval result screen 81c or 81d in order to input a reservation request for an available sales clerk displayed on retrieval result screen 81c or 81d for the customer.

WEB server 6 sends reservation information for the reservation request received on retrieval result screen 81c or 81d to management server 2 (described later) through the CGI and the back-end program whereupon management server 2 accepts the reservation request to reserve the object sales clerk available by changing the state of the object sales clerk to a reserved state.

In the first embodiment, management server 2 notifies the object sales clerk that the object sales clerk has been reserved for the customer. For example, the notification is performed by displaying reservation notification screen 81e of FIG. 12 on touch panel 81 of mobile terminal 8 carried by the object sales clerk. Reservation notification screen 81e displays customer information (a customer number, a customer name, etc.) about the customer that is to be attended to by the object sales clerk and a commodity (a vacuum cleaner in FIG. 12) the customer wished to purchase.

Management server 2 sends the reservation notification to WEB server 6 via the CGI and the back-end program whereupon WEB server 6 causes touch panel 81 of mobile terminal 8 carried by the object sales clerk to display reservation notification screen 81e.

In the present embodiment, the object sales clerk judges with reference to reservation notification screen 81e whether or not customer information (a purchase history) about a customer that reserved the object sales clerk is displayed on touch panel 81. On reservation notification screen 81e of FIG. 12, a selection for a “retrieve information about a past purchase” makes touch panel 81 display transaction history screen 81f of FIG. 13 containing a purchase history (purchase information) of the customer based on the customer information retained in customer DB 5 (see FIG. 3).

The purchase history, as shown in FIG. 13, includes indexes of a purchase date, a purchased commodity, a commodity manufacturer, and a commodity price about a past purchase by a customer. WEB server 6 instructs management server 2 via the CGI and the back-end program to make management server 2 retrieve such a purchase history in customer DB 5. The purchase history retrieved is sent to WEB server 6 through the CGI and the back-end program, and WEB server 6 displays the purchase history on touch panel 81 of mobile terminal 8.

Management server 2 manages various data retained in sales clerk DB 3, transaction DB 4, and customer DB 5, and performs various processes for various requests and data inputted from mobile terminals 8.

For example, management server 2 registers current states (of attending to a customer or of being reserved) of individual sales clerks by managing data retained in sales clerk DB 3. Namely, management server 2 serves to function as a sales-clerk-state registering section for registering states of individual sales clerks.

In response to a retrieval request for any sales clerks available to attend to a customer inputted from mobile terminal 8 (touch panel 81 or keyboard 82), management server 2 retrieves such sales clerks available from data retained in sales clerk DB 3 thereby functioning as a retrieving section.

When retrieving any sales clerks available, management server 2 refers to customer DB 5 in order to preferentially select an available sales clerk that has attended to the customer in the past. For example, when a sales clerk that has attended to a customer at a most-recent time is available, the sales clerk is preferentially reserved for the customer. As a result, since the customer is attended to by a sales clerk that the customer has been served by at a previous time, it is possible to provide an improved service to the customer. Management server 2 sends the retrieval result to WEB server 6.

Management server 2 reserves a sales clerk available for a customer based on data retained in sales clerk DB 3 and a reservation request inputted from mobile terminal 8 thereby serving to function as a reservation accepting section to accept a reservation for a sales clerk available in response to the reservation request from mobile terminal 8.

Management server 2 further notifies that an object sales clerk has been reserved by a customer. The reservation notification is carried out by reservation notification screen 81e (see FIG. 12), which shows that the object sales clerk has been reserved by the customer and which is displayed on mobile terminals 8 carried by individual sales clerks. Thereby, management server 2 serves to function as a notifying section to notify an object sales clerk that the object sales clerk has been reserved by a customer. Alternatively, such a reservation may be notified by sending an e-mail to a pre-allocated e-mail address destined for the mobile terminal carried out by the sales clerk.

Management server 2 records transaction information received from each mobile terminal 8 into transaction DB 4 and customer DB 5. Further, in response to a request to browse a purchase history of a customer, which request is input by a sales clerk using mobile terminal 8, management server 2 retrieves the corresponding purchase history in customer DB 5 and sends the retrieved purchase history to WEB server 6.

The CPU of the information processor (management server 2) executes the attendant management program that is stored in a computer-readable recording medium (e.g., a memory, a magnetic recording medium, a flexible disc, a memory card, a magneto-optic recording medium, a CD-ROM, a CD-R, a CD-RW, a DVD, a DVD-R, and a DVD-RW) so that the management server 2 serves to function as the sales-clerk-state registering section, the retrieving section, the reservation accepting section and the notifying section.

Business server 13 performs various processes (summing and managing sales or the like) in relation to transactions for which payment has been made by payment terminal 10 or mobile terminal 8. Business server 13 is communicably connected to credit card settlement system 14, which is provided by CAFIS (Credit And Financial Information System; trademark), GP-NET (trademark), or JCN (trademark) via a dedicated communication line. When payment terminal 10 is to accept a payment for one or more transactions with a credit card from a customer, business server 13 asks credit card settlement system 14 for reference, examination and settlement in terms of the credit card and obtains the results from credit card settlement system 14.

Credit card settlement system 14 performs reference, examination, settlement in terms of a credit card, on the basis of the credit card number, with which a customer intends to make a payment for one or more transactions. When a customer intends to make a payment with a credit card, business server 13 sends data about the credit card (e.g., a the credit card number) to credit card settlement system 14 through the dedicated communication line where upon the payment is settled with the credit card.

Reception terminal 9 is communicably connected to WEB server 6 and management server 2 via communication network 7, and accepts reservations for an object sales clerk who is to attend to a customer.

Reception terminal 9 has a monitor that displays WEB pages (see FIGS. 8 and 10) WEB server 6 provides, and a keyboard to input various data on such WEB pages. Browsing software is installed in reception terminal 9 to display WEB pages provided by WEB server 6.

Reception terminal 9 is disposed at a reception counter installed near to the entrance of store 50, and displays customer information screen 81a (see FIG. 8) and retrieval result screen 81c (see FIG. 10) on the screen thereof. A customer coming to shop in store 50 reserves a sales clerk that is to attend to the customer at a department where the desired commodity is sold prior to going to the department. For the operations associated with reserving a sales clerk, reception terminal 9 may be operated by a dedicated operator or a customer who is going to shop in store 50.

If a customer operates reception terminal 9 to reserve a sales clerk, it is strongly recommended that the customers should not be able to access information (e.g., a purchase history of other customers) on WEB pages of FIGS. 8 and 10 abovementioned that should not be disclosed to third persons.

Payment terminal (a receipt issuing section, a print control section, a transaction contents printing section, an attendant information printing section, and a receipt issuing apparatus) 10 is used to accept payment for transactions on which sales registrations have been performed in store 50, and is exemplified by a POS (Point Of Sales) terminal. Payment terminal 10 is communicably connected to management server 2, business server 13, and credit card settlement system 14 through communication network 7.

Payment terminal 10 makes a payment for a transaction whose holding flag “1” is set in transaction DB 4 (i.e., a transaction for which only a sales registration has been performed). In the illustrated embodiment, payment terminal 10 is disposed at a check-out area near to an exit of store 50, and accepts payment for plural transactions made with a customer in a lump sum. In other words, payment terminal 10 serves to function as a payment accepting section to accept a payment for a number of transactions (sales registrations) made with a customer in a lump sum on the basis of transaction information retained in transaction DB 4.

More specifically, payment terminal 10 derives from transaction DB 4 transaction information (one or more sales registrations) about one or more transactions made by a customer for which payment has not been made based on the customer information (e.g., a customer number, or a customer name) of the customer. After that, payment terminal 10 makes a payment for the transactions in a lump sum.

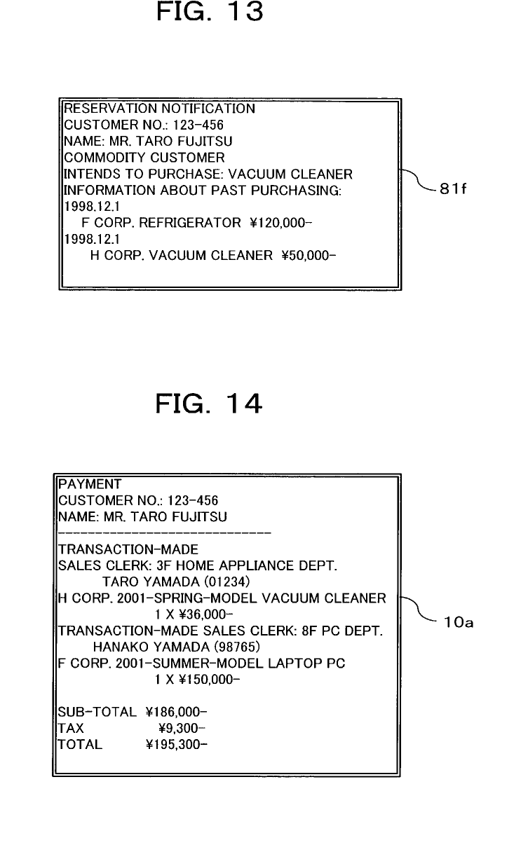

FIG. 14 shows an example of payment screen 10a displayed on the monitor of payment terminal 10. Payment screen 10a includes information about one or more sales registrations of a customer performed in store 50, as shown in FIG. 14.

Payment screen 10a is displayed on the unillustrated monitor of payment terminal 10 in order to provide the contents of the transactions (two transactions in FIG. 14) made with a customer in store 50 when payment terminal 10 accepts a payment for the transactions made in a lump sum. A name, a quantity, a price, a sub-total, a tax, a total of a commodity purchased in each transaction made with a customer (for which a sales registration has been performed) appear on payment screen 10a in addition to the number and the name of the customer. Further, the name, the number, and the department-in-charge of a sales clerk who attended to the customer when making each transaction also appears on payment screen 10a.

When accepting payment for the transactions from the customer, payment terminal 10 issues a receipt to the customer by printing the contents of the transactions thereon. For this purpose, payment terminal 10 comprises a printer to print on an un-printed rolled medium the contents (e.g., date, commodity name, quantity, commodity price, tax price, total price) of each transaction for which payment has been made.

Namely, payment terminal 10 functions as the receipt issuing section to issue a receipt to a customer by printing on a medium the contents of one or more transactions made with the customer based on transaction information retained in transaction DB 4.

The CPU (not shown) of payment terminal 10 executing a receipt issuing program recorded in a computer-readable recording medium causes payment terminal 10 to function as the transaction contents printing section to print on a receipt at least contents of each transaction, and as an attendant information printing section to print identification information to identify the attendant that has attended to a customer when making each transaction in correlation to each corresponding transaction. The computer-readable recording medium is exemplified by a memory, a magnetic recording medium, a flexible disc, a memory card, a magneto-optic recording medium, a CD-ROM, a CD-R, a CD-RW, a DVD, a DVD-R and/or a DVD-RW.

Payment terminal 10 prints on a receipt sales clerk information that identifies the sales clerk that has attended to a customer when making each transaction in addition to the contents of each transaction as described above. The sales clerk information to be printed on a receipt contains the name and the number of each sales clerk and preferably contains information that identifies a sales area (e.g., area name, area code, floor number, in-charge department, and code to identify mobile terminal 8 carried by the sales clerk).

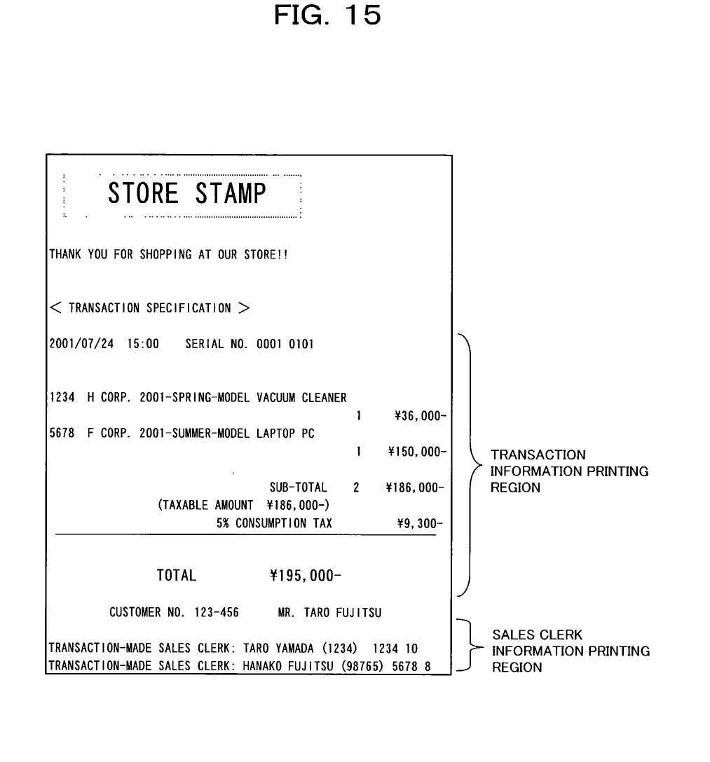

FIG. 15 illustrates an example of a receipt printed by payment terminal 10 in attendant management system 1. As shown in FIG. 15, transaction information printed on one side of a receipt includes the name of a sales clerk that has made a transaction with a customer, the sales clerk number, a sales area where the transaction was made, and a terminal number, which constitute identification information for identifying the sales clerk, in addition to transaction date and time, department code, commodity name, commodity quantity, unit price, tax, and total price.

When a customer makes a number of transactions, payment terminal 10 issues a receipt by printing the sales clerk that has made each of the transactions on the receipt. In other words, each of the transactions is correlated with the sales clerk that has made the corresponding transaction with the customer on the receipt.

A receipt to be issued is divided into two regions: a transaction information printing region and a sales clerk information printing region. Transaction date and time, transaction department code, commodity name, commodity quantity, unit price, tax, and total price are printed on the transaction information printing region; and sales clerk name, sales clerk number, sales area, and terminal number (i.e., sales clerk information) are printed on the sales clerk information printing region.

Management server 2, WEB server 6, business server 13, and each mobile terminal 8 are communicably connected to each other through communication network 7 thereby sending and receiving various data via a particular protocol, such as TCP/IP (Transmission Control Protocol/Internet Protocol). Communication network 7 includes one or more routers 11 and access points 12.

Routers 11 connect two or more LANs (Local Area Network) and a LAN to a WAN (Wide Area Network) and are installed at least one at each of the floors. Access point 12 is used for a wireless LAN that communicably connects each mobile terminal 8 to communication network 7 and is exemplified by a combination of a radio antenna and a data communication device.

Data communication on electromagnetic waves (radio waves) between a wireless interface (non-illustrated) incorporated in each mobile terminal 8 and access point 12 realizes a communicable connection of each mobile terminal 8 to communication network 7 via electromagnetic waves (radio waves). In the illustrated embodiment, since each mobile terminal 8 is connected to communication network 7 using a wireless LAN system, there is no need to connect each mobile terminal 8 to communication network 7 via a cable. Such wireless connection therefore allows a sales clerk to carry mobile terminal 8 everywhere in the store, thereby maintaining communication with communication network 7.

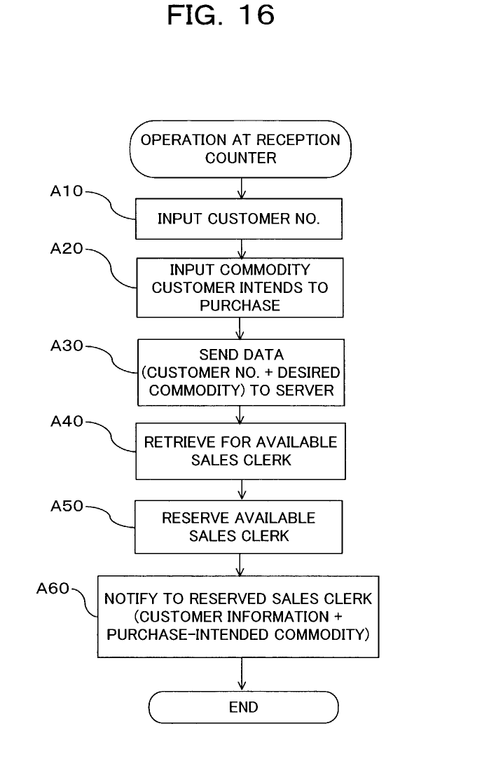

Successions of procedural steps of attending to a customer carried out in attendant management system 1 in relation to attending to a customer will now be described with reference to flow diagrams FIGS. 16 through 18. FIG. 16 illustrates a succession of procedural steps (Steps A10 to A60) performed by reception terminal 9.

First of all, a customer that visits store 50 for shopping comes to the reception counter near the entrance and shows the member card to an operator.

The operator at the reception counter scans the card to input data (e.g., customer number) recorded on the shown member card using an unillustrated scanner incorporated in reception terminal 9 or other means (Step A10). Alternatively, a customer number may be obtained and input by a retrieval in customer DB 5 based on the customer's name or telephone number.

The operator asks the customer what to purchase and then inputs the commodity that the customer intends to purchase in reception terminal 9 (Step A20). Upon input of the desired commodity, customer information screen 81a as shown in FIG. 8 is displayed on the monitor of reception terminal 9.

The operator sends the data (of the customer number and the desired commodity) to management server 2 (Step A30). After that, the operator inputs a retrieval request by selecting “retrieve available sales clerk” in sales clerk retrieval screen 81b (see FIG. 9) displayed on the monitor whereupon management server 2 retrieves any sales clerks available to attend to the customer (Step A40) based on a history of past sales clerk attendance in customer DB 5, “the state” and “a reservation number” of individual sales clerk stored in sales clerk DB 3. Management server 2 sends the retrieval result to WEB server 6.

In response to the receipt of the retrieval result, WEB server 6 creates retrieval result screen 81c (see FIG. 10) that is to be displayed on the monitor of reception terminal 9. The operator inputs a reservation request to reserve an available sales clerk for the customer (Step A50) by selecting a “reserve” on retrieval result screen 81c. The reservation request is sent to management server 2 via WEB server 6 whereupon management server 2 inputs the customer number in the index of “reservation number” of the available sales clerks (the object sales clerk) in sales clerk DB 3 if the reservation request is accepted.

Management server 2 notifies the object sales clerk that the object sales clerk is reserved by the customer (Step A60) and completes the succession of the procedural steps. In the illustrated example, the reservation notification is carried out by WEB server 6 making mobile terminal 8 display a WEB page (see FIG. 12) so that the object sales clerk can see the reservation notification through touch panel 81 of mobile terminal 8.

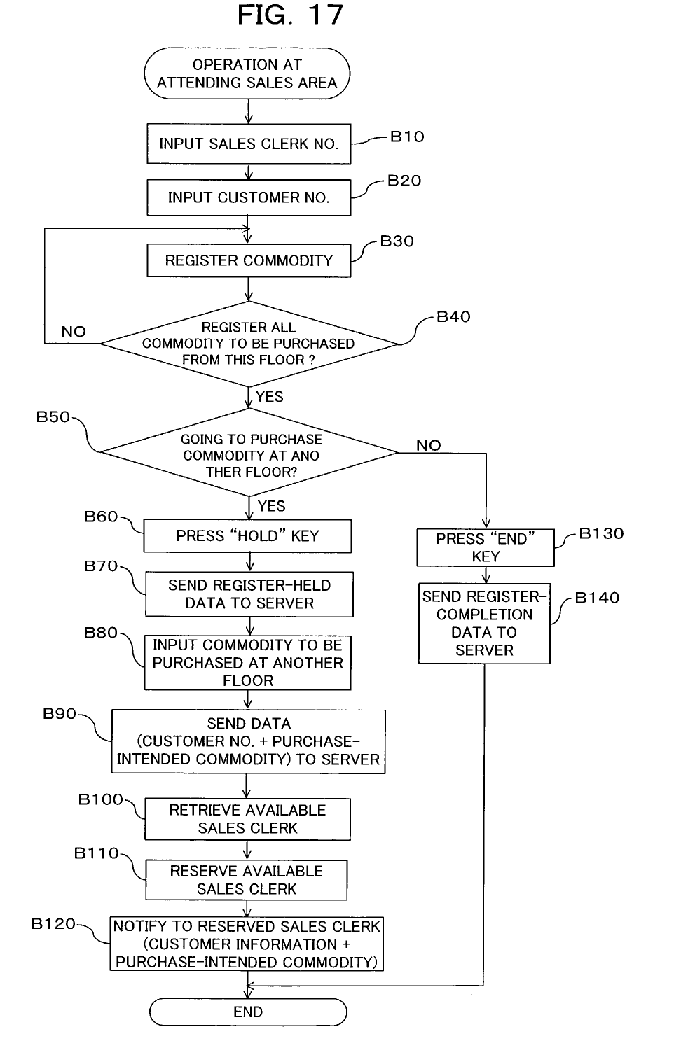

Now, the procedural steps (Steps B10 to B140) of a sales clerk using mobile terminal 8 attending to a customer at individual sales area in store 50 will now be described with reference to FIG. 17.

Prior to attending to a customer, a sales clerk inputs the sales clerk number to mobile terminal 8 (Step B10). The input of the sales clerk number is performed by input from touch panel 81 or keyboard 82, or by scanning the ID card with scanner 84 or MCR 83.

If one mobile terminal 8 is dedicated to an individual sales clerk, the input of sales clerk number can be eliminated and identification of each sales attendant may utilize ID information (e.g., a network ID, or a terminal number) previously allocated to each mobile terminal 8.

After that, the sales clerk inputs the number of a customer to be attended to by the sales clerk into mobile terminal 8 (Step B20). The input of the customer number is also performed by input from touch panel 81 or keyboard 82, or by scanning the member card by scanner 84 or MCR 83.

Upon completion of attending to the customer resulting in a purchase of one or more commodities, the sales clerk registers transaction information (such as commodity name, commodity quantity, unit price) in mobile terminal 8 (in other words, performs a purchase registration, Step B30) for a purchase registration. A purchase registration is performed by scanning a barcode attached to each of the commodities that are to be purchased and/or inputting information from touch panel 81 or keyboard 82. Then the sales clerk confirms whether purchase registrations for all commodities that the customer intends to purchase at the sales area (floor) (Step B40). If the confirmation result is negative (No route in Step B40), the procedural steps return to Step B30 and the sales clerk continues to attend to the customer until another purchase registration is completed. During a purchase registration, touch panel 81 of mobile terminal 8 displays thereon purchase registration screen 81g (see FIG. 7).

Upon completion of purchase registration for all commodities that the customer intends to purchase at the floor (Yes route in Step B40), the sales clerk confirms whether the customer intends to purchase a commodity (on which a purchase registration is performed) at another sales area (floor) (Step B50). If purchase registrations are performed on all of the commodities that the customer intends to purchase (No route in Step B50), the sales clerk selects (presses) the “end” button on purchase registration screen 81g (Step B130). Responsive to the press of the “end” button, transaction information (registered transaction data) registered in mobile terminal 8 at Step B30 is sent to management server 2 via communication network 7 (Step B140) and management server 2 sets the holding flag in relation to the received purchase registration to “0” in transaction DB 4 for the sales clerk to complete attending to the customer.

On the other hand, if the customer continues to shop at another floor (Yes route in Step B50), the sales clerk selects (presses) the “hold” button on purchase registration screen 81g (Step B60). Transaction information (registration held data) registered heretofore in mobile terminal 8 is sent to management server 2 through communication network 7 (Step B70), management server 2 sets the holding flag in relation to the received purchase registration to “1” (being held) in transaction DB 4.

Further, the sales clerk confirms what and/or at which floor the customer intends to make a purchase in order to input a commodity that the customer intends to purchase at another floor (Step B80). Data of a combination of the customer number and the desired commodity is sent to management server 2 (Step B90).

The sales clerk selects “retrieve available sales clerk” on purchase registration screen 81b, a retrieval request is sent to management server 2 via WEB server 6. In response to the retrieval request, management server 2 retrieves any sales clerks available to attend to the customer on the floor at which the customer intends to continue shopping (Step B100). When retrieving any available sales clerks, management server 2 refers to customer DB5 and displays the retrieval result in such an order suitable for preferentially reserving the sales clerk that attended to the customer his/her most-recent purchase on the corresponding floor. WEB server 6 makes touch panel 81 of mobile terminal 8 display retrieval result screen 81d (see FIG. 11) containing the retrieval result.

When the sales clerk selects the “retrieve” button on retrieval result screen 81d, management server 2 reserves the available sales clerk (the object sales clerk) displayed on the retrieval result screen 81d (Step B110) by changing the current state of the object sales clerk to a reserved state. Then management server 2 notifies the object sales clerk that the object sales clerk has been reserved by the customer (Step B120) to complete the procedural steps. In the illustrated embodiment, management server 2 performs the reservation notification by causing the mobile terminal 8 carried by the object sales clerk to display reservation notification screen 81e (see FIG. 12).

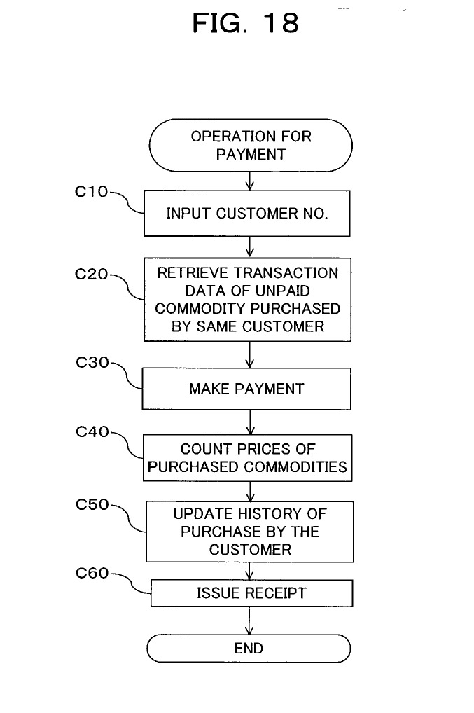

A succession of procedural steps (Steps C10 to C60) of an operation performed by payment terminal 10 in attendant management system 1 will now be described with reference to FIG. 18. After purchase registrations for all of the commodities that the customer intends to purchase in store 50, the customer pays for all of the commodities in a lump sum at the payment area at which payment terminal 10 is installed.

The customer shows the member card to a payment-accepting operator at the payment area. The payment-accepting operator inputs customer information (e.g., customer number) recorded on the member card via a scanner (not shown) incorporated in payment terminal 10 (Step C10). Alternatively, the customer number may be obtained by retrieval in customer DB 5 based on the customer's name or telephone number.

The customer number input at Step C10 is sent to management server 2 through communication network 7. Responsive to the receipt of the customer number, management server 2 retrieves in transaction DB 4 any transactions which have been made with the customer and for which payments have not been made yet, i.e., any transactions whose holding flags are set to “1” (Step C20). The retrieval result for unpaid transactions is sent to payment terminal 10.

Payment terminal 10 performs payment acceptance operations (settlement operations) for held transactions in a lump sum in response to the retrieval result from management server 2 (Step C30). Payment screen 10a (see FIG. 14) containing information about the held transactions is displayed on a monitor of payment terminal 10.

If the customer wishes to pay for the transactions with a credit card, information of the credit card is sent to credit card settlement system 14 through communication network 7 and business server 13. Then credit card settlement system 14 performs reference, examination, and settlement in relation to the credit card.

Data of the contents of transactions for which payment has been settled is sent to business server 13 (Step C40), which counts and manages the transactions made with the customer. The data of the contents of the transactions is also sent to management server 2, which updates transaction DB 4 and customer DB 5 based on the received data. The updating is exemplified by recording transaction information about the transactions as a transaction history in customer DB 5 as well as by updating a holding flag in transaction DB 4 and by inputting the total price, the quantity, and the tax of each of the transactions (Step C50).

Payment terminal 10 issues a receipt on which the contents of the transactions for which payments have been accepted are printed (Step C60). Identification information (e.g., sales area and sales clerk name) to identify the sales clerk who attended to the customer when making each of the transactions is printed on the receipt. Especially, if the customer made a number of transactions (purchase registrations), payment terminal 10 prints on a receipt the name and the number of the sales clerk that attended to the customer when each of the transactions were made.

The customer receives a receipt on which identification information about the sales clerk that attended to the customer when making the transactions is printed in addition to the contents of each transaction. A commodity that a customer purchased is handed over to the customer at the sales area where the purchase registration was made, or at the payment area. Various modifications and alterations may be suggested without departing from the gist of the present invention.

When the customer later makes a query in terms of the purchased commodity of a transaction, the customer can make contact with the sales clerk that attended to the customer when making the transaction based on the information printed on the receipt.

As mentioned above, management server 2 manages states of the individual sales clerks and can therefore retrieve any sales clerks available to attending to a customer to reserve one for the customer. As a result, since a customer does not have to find an available attendant at a sales area, and wait to be attended to until a sales clerk becomes available, it is possible to enhance service to customers. The advantage is also of benefit to the store in terms of avoiding loss of sales opportunity.

Since the state of each sales clerk can be checked with mobile terminal 8, it is possible to reserve an available attendant with ease thereby enhancing service to customers. Further, since management server 2 notifies such reserved sales clerks of customer reservations, the reserved (object) sales clerk can easily grasp the reservation without time delay.

Partly since the display of a retrieval request and a retrieval result and inputting of a reservation request, and the like are realized on WEB pages provided by WEB server 6, and partly since each mobile terminal 8 requires only a WEB browser to display such WEB pages, it is possible to reduce the developing and manufacturing costs of each mobile terminal 8. If items on WEB pages are changed for an alternative and a modification of attendant management system 1 of the present invention, there is no requirement to change applications installed in each mobile terminal 8 and reception terminal 9 and only a change in object WEB data for WEB server 6 is required. Thereby, it is possible to reduce maintenance costs for the system.

When a customer has purchased a plurality of commodities at a number of sales areas, where only purchase registrations for transactions are performed, payment terminal 10 accepts payment for the transactions in a lump sum. Payment at each of the sales areas can be therefore omitted and it is possible to improve customer service, reducing the labor and time for individual payments. As an advantage for a store, since each floor or sales area does not need to have equipment installed for accepting payment (such as a POS terminal), it is possible to reduce costs for facilities and the amount of small change that is given to customers.

Payment terminal 10 prints on a receipt, which is to be issued to a customer, identification information (e.g., sales clerk name and number, department-in-charge, and terminal number) to identify a sales clerk that attended to a customer when making each transaction. Since it is possible to easily specify the sales clerk that attended to a customer when making each transaction with reference to an issued receipt, the customer can easily make contact with the sales clerk with queries about a commodity purchased when being attended to by the sales clerk thereby receiving improved service from the store.

When a customer has made a number of purchases (transactions), payment terminal 10 prints on the receipt identification information to identify the sales clerk who attended to the customer when making each of the purchases. Namely, identification information in relation to a sales clerk is printed on a receipt in correlation with the corresponding transaction made by the customer when the sales clerk attended to the customer. As a result, since it is possible for a customer to easily specify the sales clerk that attended to the customer when making one of a number of transactions, the service to the customer is improved even if the customer made a number of transactions at one time.

The present invention should by no means be limited to this foregoing embodiment, and various changes or modifications may be suggested without departing from the gist of the invention.

In the illustrated example, an individual sales clerk carries one mobile terminal 8. Alternatively, one mobile terminal 8 may be shared by a number of sales clerks.

In the illustrated embodiment, an individual sales clerk inputs the state through mobile terminal 8 each time the states turns to another. Alternatively, a sales clerk may input the current state from a device other than mobile terminal 8.

Further, WEB pages provided by WEB server 6 should by no means be limited to the above-mentioned example, and various alternatives thereof are suggested. For example, sales clerk retrieval screen 81b of FIG. 9 may include choices of “department-in-charge”, “sales clerk”, “floor” and the like, and the retrieval of any available sales clerk is performed in terms of one of the above mentioned choices by selection on the sales clerk retrieval screen 81b.

Alternatively, each customer may be attended to by an associated sales clerk at a certain floor or area in stores, which sales clerk is previously allocated to the customer. For such an allocation, the associated sales clerk for a customer preferentially may attend to the customer if available.

Further, payment may be made at each sales area at the same time as a purchase registration when a customer intends to purchase small quantities of commodities or a customer wishes to.

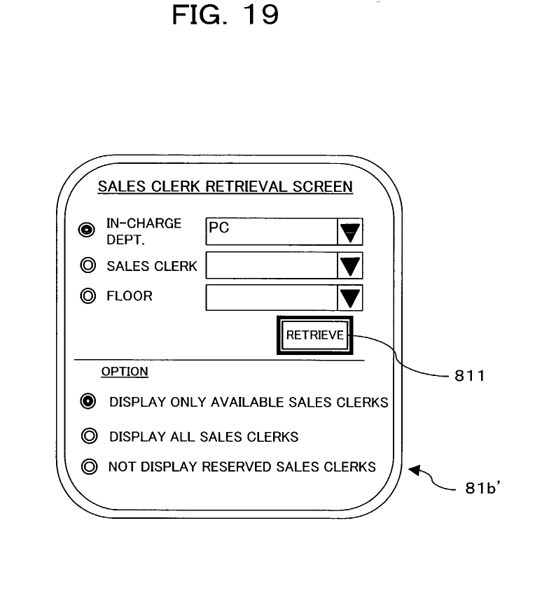

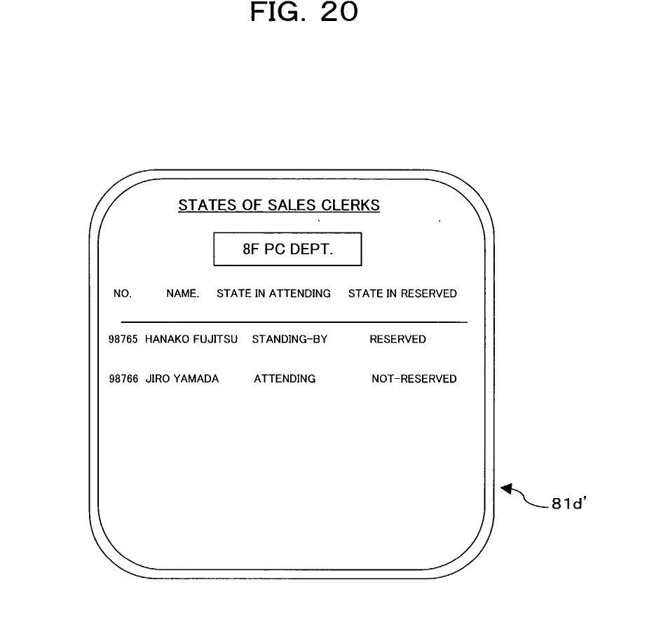

FIG. 19 is a modification of sales clerk retrieval screen 81b in attendant management system 1. In sales clerk retrieval screen 81b′ of FIG. 19, “sales clerk” is selected from three choices and additionally, selects one or more particular sales clerks from a list of sales clerks. After these selections, a press of “retrieve” button 811 prompts retrieval for the status of each of the selected sales clerks in accordance with the selected option.

Alternatively, it may be possible to select the “department-in-charge” in sales clerk retrieval screen 81b′ and to further select one from plural departments (e.g., vacuum cleaners, air conditioners, beauty products, clothes washers, and PCs), in which one department a customer intends to purchase a commodity. In FIG. 7, a PC is selected as the item that a customer intends to purchase. After selection, pressing of “retrieve” button 811 causes a retrieval for the state of every sales clerk that is available to attend to the customer at the selected department.

Further, when “floor” is selected on sales clerk retrieval screen 81b′, a particular floor (e.g., 2F or 3F) can be also selected among all floors in the store 50. After that, a press of the “retrieve” button 811 starts retrieval for the state of each sales clerk disposed at the selected particular floor.

In the modification shown in FIG. 19, a mode of displaying a retrieval result is selected from three options of “display only available sales clerks”, “display all sales clerks”, and “not display reserved sales clerks”. With the first option of “display only available sales clerks,” only sales clerks who are on stand-by (i.e., available sales clerks that are not attending to customers) will be displayed; with the second option of “display all sales clerks”, all the sales clerks that satisfy a requirement for the retrieval irrespective of their state will be displayed; and with the third option of “not display reserved sales clerks”, the retrieval result to be displayed will not include any sales clerks that are reserved by another customer.

FIG. 20 shows a modification of retrieval result screen 81d of attendant management system 1. A retrieval result screen 81d′ of FIG. 20 takes the form of a list of information about a number of sales clerks satisfied with a retrieval requirement. With such a list of information about sales clerks, it is possible to easily grasp the current state of each sales clerk satisfied with the retrieval requirement thereby enhancing service to customers.

In the illustrated embodiment, retrieval result screen 81d for mobile terminal 8 is different from retrieval result screen 81c for reception terminal 9; however retrieval result screens 81c and 81d may be identical.

What is claimed is:

1. A system for managing a number of attendants, each of which attends to one or more customers at one of a plurality of attending areas, comprising:
an attendant-state registering section for registering states of the individual attendants;
a retrieval-request receiving section for receiving a retrieval request to retrieve any attendants available for attending to a customer at a particular one of the plural attending areas;
a retrieving section, responsive to said retrieval request received by said retrieval-request receiving section, for retrieving such available attendants based on the states of the individual attendants registered by said attendant-state registering section;
a retrieving result displaying section for displaying the result of the retrieving performed by said retrieving section;
a reservation-request receiving section for receiving a request to reserve one of the available attendants with reference to the result of the retrieving displayed on said retrieving result displaying section;
a reservation accepting section, responsive to the reservation request received by said reservation request receiving section, for accepting the reservation by making said attendant-state registering section register that the object attendant turns to a reserved state; and
a notifying section for notifying the object attendant that the object attendant has been reserved by the customer.

2. A system according to claim 1, further comprising:
two or more terminal units, each of which has said retrieval-request receiving section, said retrieving result displaying section, and said reservation-request receiving section; and
a management unit communicably connected to each of said terminal units and having said attendant-state registering section, said retrieving section, said reservation accepting section, and said notifying section.

3. A system according to claim 1, wherein:
said terminal units are disposed at least one at each of said two or more attending areas;
each said terminal unit includes a transaction information receiving section for receiving transaction information about one or more transactions made with the customer in the attending area at which each said terminal unit is disposed; and
said management unit further includes
a transaction information retaining section for retaining said transaction information received by said transaction information receiving section of each said terminal unit, and
a payment accepting section for accepting a payment for the transactions made with the customer in a lump sum based on said transaction information retained by said transaction information retaining section.

4. A system according to claim 2, wherein:
said terminal units are disposed at least one at each of said two or more attending areas;
each said terminal unit includes a transaction information receiving section for receiving transaction information about one or more transactions made with the customer in the attending area at which each said terminal unit is disposed; and
said management unit further includes
a transaction information retaining section for retaining said transaction information received by said transaction information receiving section of each said terminal unit, and
a payment accepting section for accepting a payment for the transactions made with the customer in a lump sum based on said transaction information retained by said transaction information retaining section.

5. A system according to claim 3, further comprising:
a receipt issuing section, responsive to the accepting of the payment by said payment accepting section, for issuing a receipt by printing the contents of the transactions for which the payment has been accepted based on said transaction information retained by said transaction information retaining section is printed; and
a print control section for controlling said receipt issuing section such that said receipt issuing section prints identification information to identify the attendant having attended to the customer when making each of the transactions in correlation with the last-named each transaction.

6. A system according to claim 4, further comprising:
a receipt issuing section, responsive to the accepting of the payment by said payment accepting section, for issuing a receipt by printing the contents of the transactions for which the payment has been accepted based on said transaction information retained by said transaction information retaining section is printed; and
a print control section for controlling said receipt issuing section such that said receipt issuing section prints identification information to identify the attendant having attended to the customer when making each of the transactions in correlation with the last-named each transaction.

7. A system according to claim 1, further comprising:
a customer information receiving section for receiving customer information (a history of purchasing or the like) about the customer; and
a customer information retaining section for retaining said customer information received by said customer information receiving section,
each said terminal units including a customer information displaying section for displaying thereon said customer information retained in said customer information retaining section.

8. A system according to claim 2, further comprising:
a customer information receiving section for receiving customer information (a history of purchasing or the like) about the customer; and
a customer information retaining section for retaining said customer information received by said customer information receiving section,
each said terminal units including a customer information displaying section for displaying thereon said customer information retained in said customer information retaining section.

9. A system according to claim 3, further comprising:
a customer information receiving section for receiving customer information (a history of purchasing or the like) about the customer; and
a customer information retaining section for retaining said customer information received by said customer information receiving section,
each said terminal units including a customer information displaying section for displaying thereon said customer information retained in said customer information retaining section.

10. A system according to claim 4, further comprising:
a customer information receiving section for receiving customer information (a history of purchasing or the like) about the customer; and
a customer information retaining section for retaining said customer information received by said customer information receiving section,
each said terminal units including a customer information displaying section for displaying thereon said customer information retained in said customer information retaining section.

11. A system according to claim 5, further comprising:
a customer information receiving section for receiving customer information (a history of purchasing or the like) about the customer; and
a customer information retaining section for retaining said customer information received by said customer information receiving section,
each said terminal units including a customer information displaying section for displaying thereon said customer information retained in said customer information retaining section.

12. A system according to claim 6, further comprising:
a customer information receiving section for receiving customer information (a history of purchasing or the like) about the customer; and
a customer information retaining section for retaining said customer information received by said customer information receiving section,
each said terminal units including a customer information displaying section for displaying thereon said customer information retained in said customer information retaining section.

13. A system according to claim 2, wherein each said terminal unit is a mobile device.

14. A system according to claim 3, wherein each said terminal unit is a mobile device.

15. A system according to claim 4, wherein each said terminal unit is a mobile device.

16. A system according to claim 5, wherein each said terminal unit is a mobile device.

17. A system according to claim 6, wherein each said terminal unit is a mobile device.

18. A system according to claim 7, wherein each said terminal unit is a mobile device.

19. A system according to claim 8, wherein each said terminal unit is a mobile device.

20. A system according to claim 9, wherein each said terminal unit is a mobile device.

21. A system according to claim 10, wherein each said terminal unit is a mobile device.

22. A system according to claim 11, wherein each said terminal unit is a mobile device.

23. A system according to claim 12, wherein each said terminal unit is a mobile device.

24. An apparatus for managing a number of attendants, each of which attends to one or more customers at one of a plurality of attending areas, comprising:
an attendant-state registering section for registering states of the individual attendants;
a retrieving section, responsive to receipt of a retrieval request to retrieve any attendants available for attending to a customer at a particular one of said plural attending area, for retrieving such available attendants based on the states of the individual attendants registered by said attendant-state registering section;
a reservation accepting section, responsive to receipt of a reservation request to reserve one of the available attendants with reference to the result of the retrieving, for accepting the reservation by making said attendant-state registering section register that the object attendant turns to a reserved state; and
a notifying section for notifying the object attendant that the object attendant has been reserved by the customer.

25. An apparatus according to claim 24, further comprising:
a transaction information retaining section for retaining transaction information about one or more transactions made with the customer; and
a payment accepting section for accepting a payment for the transactions made with the customer in a lump sum based on said transaction information retained by said transaction information retaining section.

26. An apparatus according to claim 25, further comprising a print control section for controlling, when said payment accepting section accepts the payment, printing identification information to identify the attendant having attended to the customer when making each of the transactions in correlation with the last-named each transaction.

27. An apparatus according to claim 24, further including a customer information retaining section for retaining customer information about the customer.

28. An apparatus according to claim 25, further including a customer information retaining section for retaining customer information about the customer.

29. An apparatus according to claim 26, further including a customer information retaining section for retaining customer information about the customer.

30. A mobile terminal operable by an attendant that attends to one or more customer at one of a plurality of attending areas, comprising
a retrieval-request receiving section for receiving a retrieval request to retrieve any attendants available for attending to a customer at a particular one of the plural attending areas;
a retrieving result displaying section for displaying a result of retrieving performed in response to said retrieval request received by said retrieval-request receiving section; and
a reservation-request receiving section for receiving a request to reserve one of the available attendants with reference to the result of the retrieving displayed on said retrieving result displaying section.

31. A mobile terminal according to claim 30, further comprising a customer information displaying section for displaying thereon customer information about the customer.

32. A method for managing a number of attendants, each of which attends to one or more customers at one of a plurality of attending areas, comprising the steps of:
(a) registering states of the individual attendants;
(b) receiving a retrieve request to retrieve any attendants available for attending to a customer at a particular one of the plural attending areas;
(c) retrieving, responsive to said retrieval request received in said retrieval-request receiving step (b), such available attendants based on the states of the individual attendants registered in said attendant-state registering step (a);
(d) displaying the result of the retrieving in said retrieving step (c);
(e) receiving a request to reserve one of the available attendants with reference to the result of the retrieving displayed in said retrieving result displaying step (d);
(f) accepting, responsive to the reservation request received in said reservation request receiving step (e), the reservation by registering that the object attendant turns to a reserved state; and
(g) notifying the object attendant that the object attendant has been reserved by the customer.

33. A method according to claim 32, further comprising the steps of:
(h) receiving transaction information about one or more transactions made with the customer at two or more of the plural attending area;
(i) retaining the transaction information received in said transaction information receiving step (h); and
(j) accepting a payment for the transactions made with the customer in a lump sum based on the transaction information retained in said transaction information retaining step (i).

34. A method according to claim 33, further comprising the steps of:
upon said payment accepting step (j)
(k) issuing a receipt by printing the contents of the transactions for which the payment has been accepted based on said the transaction information retained in said transaction information retaining step (i); and
(l) controlling said payment information printing step (k) such that identification information to identify the attendant having attended to the customer when making each of the transactions is printed on the receipt in correlation with the last-named each transaction.

35. A method according to claim 32, further comprising the steps of:
(m) receiving customer information (a history of purchasing or the like) about the customer;
(n) retaining said customer information received in said customer information receiving step (m); and
(o) displaying said customer information retained in said customer information retaining step (n).

36. A method according to claim 33, further comprising the steps of:
(m) receiving customer information (a history of purchasing or the like) about the customer;
(n) retaining said customer information received in said customer information receiving step (m); and
(o) displaying said customer information retained in said customer information retaining step (n).

37. A method according to claim 34, further comprising the steps of:
(m) receiving customer information (a history of purchasing or the like) about the customer;
(n) retaining said customer information received in said customer information receiving step (m); and
(o) displaying said customer information retained in said customer information retaining step (n).

38. A computer-readable recording medium in which a customer attending management program for managing a number of attendants, each for attending to one or more customers at one of a plurality of attending areas, is stored, said program instructing a computer to function as:
an attendant-state registering section for registering states of the individual attendants;
a retrieving section, responsive to receipt of a retrieval request to retrieve any attendants available for attending to a customer at a particular one of said plural attending area, for retrieving such available attendants based on the states of the individual attendants registered by said attendant-state registering section;
a reservation accepting section, responsive to receipt of a reservation request to reserve one of the available attendants with reference to the result of the retrieving, for accepting the reservation by making said attendant-state registering section register that the object attendant turns to a reserved state; and
a notifying section for notifying the object attendant that the object attendant has been reserved by the customer.

39. A computer-readable recording medium according to claim 38, said program further instructing a computer to function as:
a transaction information retaining section for retaining transaction information about one or more transactions made with the customer; and
a payment accepting section for accepting a payment for the transactions made with the customer in a lump sum based on said transaction information retained by said transaction information retaining section.

40. A computer-readable recording medium according to claim 39, said program further instructing a computer to function as a print control section for controlling, when said payment accepting section accepts the payment, printing identification information to identify the attendant having attended to the customer when making each of the transactions in correlation with the last-named each transaction.

41. A computer-readable recording medium according to claim 38, said program further instructing a computer to function as a customer information retaining section for retaining customer information about the customer.

42. A computer-readable recording medium according to claim 39, said program further instructing a computer to function as a customer information retaining section for retaining customer information about the customer.

43. A computer-readable recording medium according to claim 40, said program further instructing a computer to function as a customer information retaining section for retaining customer information about the customer.

44. A method for issuing a receipt, on which information about two or more transactions made with a customer is printed, comprising the steps of:
printing at least contents of each of the transactions on the receipt; and
printing on the receipt identification information to identify the attendant having attended to the customer when making each of the transactions in correlation with the last-named each transaction.

45. An apparatus for issuing a receipt, on which information about two or more transactions have been made with a customer is printed, comprising:
a transaction contents printing section for printing at least contents each of the transactions on the receipt; and
an attendant information printing section for printing on the receipt identification information to identify the attendant having attended to the customer when making each of the transactions in correlation with the last-named each transaction.

46. A computer-readable recording medium in which a receipt issuing program for issuing a receipt on which information about two or more transaction made with a customer, said program instructing a computer to function as:
printing at least contents of each of the transactions on the receipt; and
printing on the receipt identification information to identify the attendant having attended to the customer when making each of the transactions in correlation with the last-named each transaction.

47. A receipt on which information about two or more transaction is printed, comprising:
a transaction information printing region on which at least contents of each of said transactions having made with a customer are operable to be printed; and
an attendant information printing region on which identification information to identify the attendant having attended to the customer when making each of the transactions in correlation with the last-named each transaction is operable to be printed.
